(19) United States
(12) Patent Application Publication
(10) Pub. No.: US 2013/0322709 A1
(43) Pub. Date: Dec. 5, 2013

(54) USER IDENTITY DETECTION ON INTERACTIVE SURFACES

(71) Applicants: Pourang Irani, Winnipeg (CA); Hong Zhang, Winnipeg (CA)

(72) Inventors: Pourang Irani, Winnipeg (CA); Hong Zhang, Winnipeg (CA)

(73) Assignee: University of Manitoba, Winnipeg, MB (CA)

(21) Appl. No.: 13/997,995

(22) PCT Filed: May 2, 2012
(86) PCT No.: PCT/CA12/50283

§ 371 Date: Aug. 26, 2013

(51) Int. Cl. G06K 9/00

(52) U.S. Cl. CPC G06K 9/00013
USPC 382/124

(57) ABSTRACT

Technologies are generally provided for customizing operational aspects of a computing system associated with an interactive surface based on determining user identity through detection of one or more user identity attributes on the interactive surface. User identity attributes such as a finger orientation, a finger weight/pressure, a separation between fingers, a finger length, an arm orientation, a handedness, a posture, a DNA, or similar unique features of a user may be detected through an input device associated/integrated with the interactive surface, for example, by employing a camera-based Frustrated Total Internal Reflection (FTIR) system for capturing finger orientation through infrared light reflection, an overhead camera, or through Diffuse Illumination. Multiple attributes may be used to increase a confidence level in user identity determination in synchronous or asynchronous shared use of the interactive surface.

### BACKGROUND

Unless otherwise indicated herein, the materials described in this section are not prior art to the claims in this application and are not admitted to be prior art by inclusion in this section.

Traditional media equipment and computer controlled devices such as computers, televisions, message boards, electronic billboards, and monitoring devices are controlled directly over a user interface using input hardware. Typically, they are directly controlled using input devices such as a mouse, remote control, keyboard, stylus, touch screen, or the like for controlling the device. Since the input devices are integrated with the devices, in order for users to interact with a device, the users need to have direct access to or be in close proximity to such input devices and screens in order to initiate actions on, operate and control the devices through keystrokes on a keyboard, movements of a mouse, and selections on a touchscreen. If the input devices are not directly accessible to the users, the interaction between the user and the devices may be limited and the user may not be able to operate and control the devices, thus limiting the usefulness of the devices.

While modern devices such as mobile devices, wall panels, and similar ones offer enhanced interactivity through touch and/or gesture detection, one challenge with such devices is ease of use when multiple users attempt to use the same device even at different times. Each user may have different needs, may employ different applications, and/or may be associated with different credentials (e.g., sign-on credentials). Such interactive devices typically do not know which user is interacting with the device resulting in a lack of personalizing features, such as maintaining a user profile, an individual user's undo/redo, and so on.

### SUMMARY

The present disclosure generally describes technologies for detecting user identity on interactive surfaces and customization based on the detected identity.

According to some examples, a method for detecting user identity on interactive surfaces may include detecting a user identity attribute on an interactive surface, determining a user identity based on the detected attribute, determining a customization operation associated with the user identity, and performing the customization operation.

According to other examples, a computing device capable of customizing operational aspects based on detecting a user identity may include a memory configured to store instructions and a processing unit configured to execute a customization module in conjunction with the instructions. The customization module may be configured to detect a user identity attribute on an interactive surface associated with the computing device, determine the user identity based on the detected attribute, determine a customization operation associated with the user identity, and perform the customization operation.

According to further examples, a computer-readable storage medium may have instructions stored thereon for detecting user identity on interactive surfaces. The instructions may include detecting a user identity attribute on an interactive surface, determining a user identity based on the detected attribute, determining a customization operation associated with the user identity, and performing the customization operation.

According to yet other examples, a user identity based customization module for use in conjunction with an interactive surface may include an input device associated with the interactive surface and a processing unit. The processing unit may detect a user identity attribute on the interactive surface, determine the user identity based on the detected attribute, determine a customization operation associated with the user identity, and perform the customization operation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A through 1D illustrate example interactive devices, where various customizations may be performed based on detected user identity;

FIG. 2 illustrates major components and interactions in an interactive system capable of customization based on detected user identity;

FIG. 3 illustrates a general purpose computing device, which may be used to customize operational aspects of an interactive surface based on user identity detection;

FIG. 4 illustrates a special purpose processor based system for customizing operational aspects of an interactive surface based on user identity detection;

FIG. 5 is a flow diagram illustrating an example method that may be performed by a computing device such as the device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to detecting user identity on interactive surfaces and customization based on the detected identity.

Briefly stated, technologies are generally provided for customizing operational aspects of a computing system associated with an interactive surface based on determining user identity through detection of one or more user identity attributes on the interactive surface. User identity attributes such as a finger orientation, a finger weight/pressure, a separation between fingers, a finger length, an arm orientation, a handedness, a posture, a DNA, or similar unique features of a user may be detected through an input device associated/integrated with the interactive surface, for example, by employing a camera-based Frustrated Total Internal Reflection (FTIR) system for capturing finger orientation through infrared light reflection, an overhead camera, or through Diffuse Illumination. Multiple attributes may be used to increase a confidence level in user identity determination in synchronous or asynchronous shared use of the interactive surface.

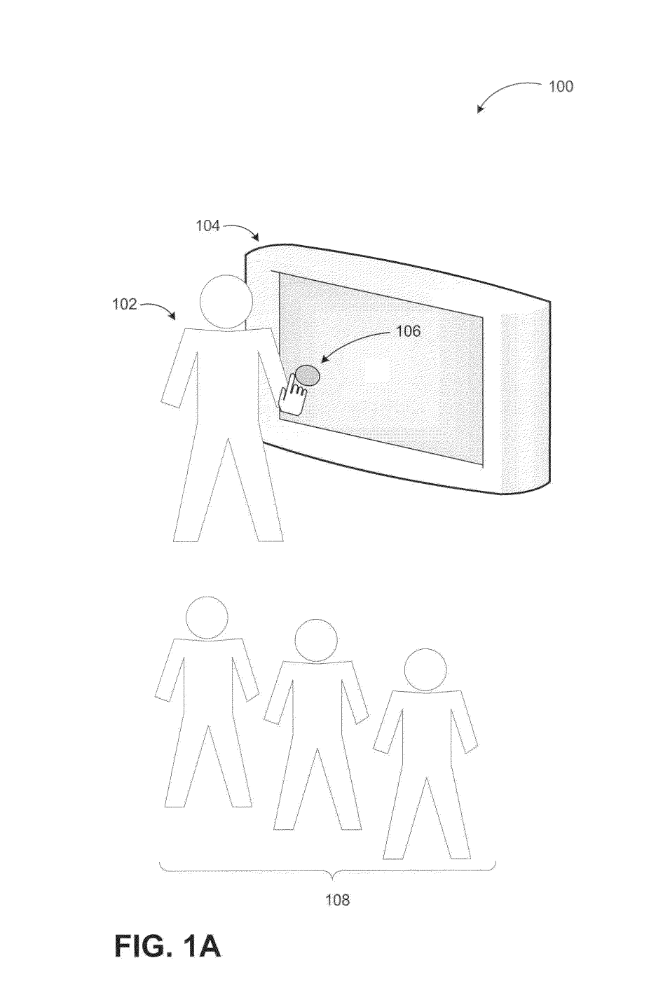

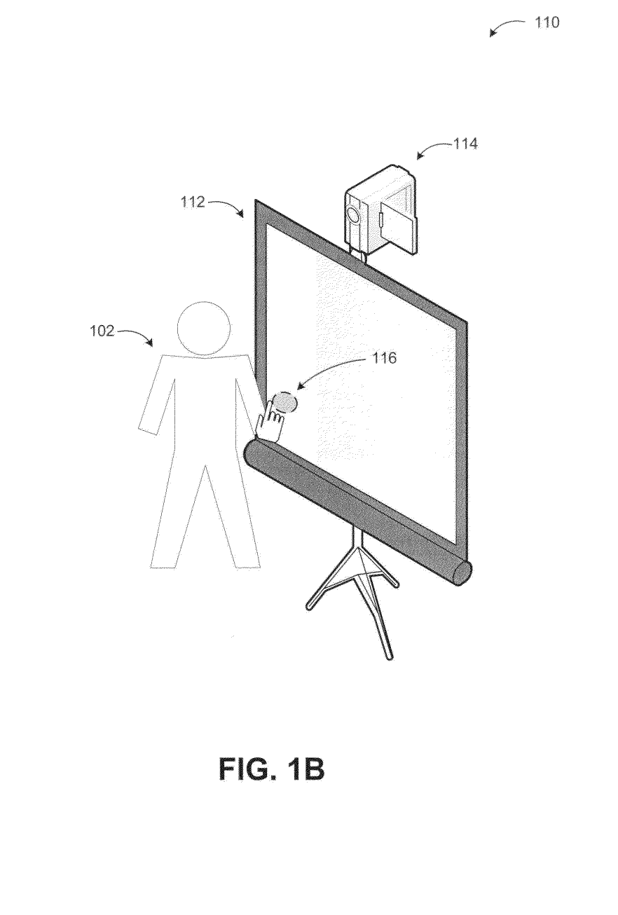

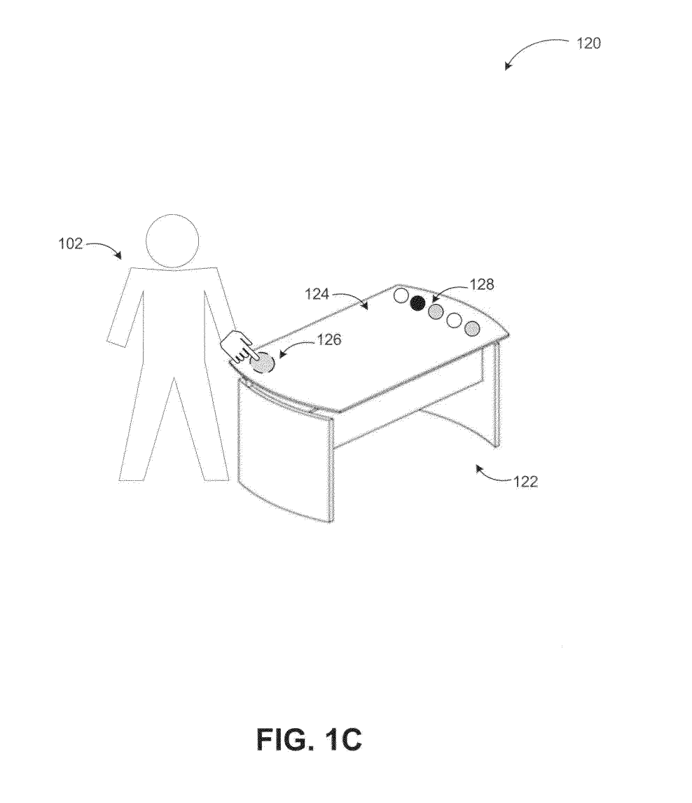

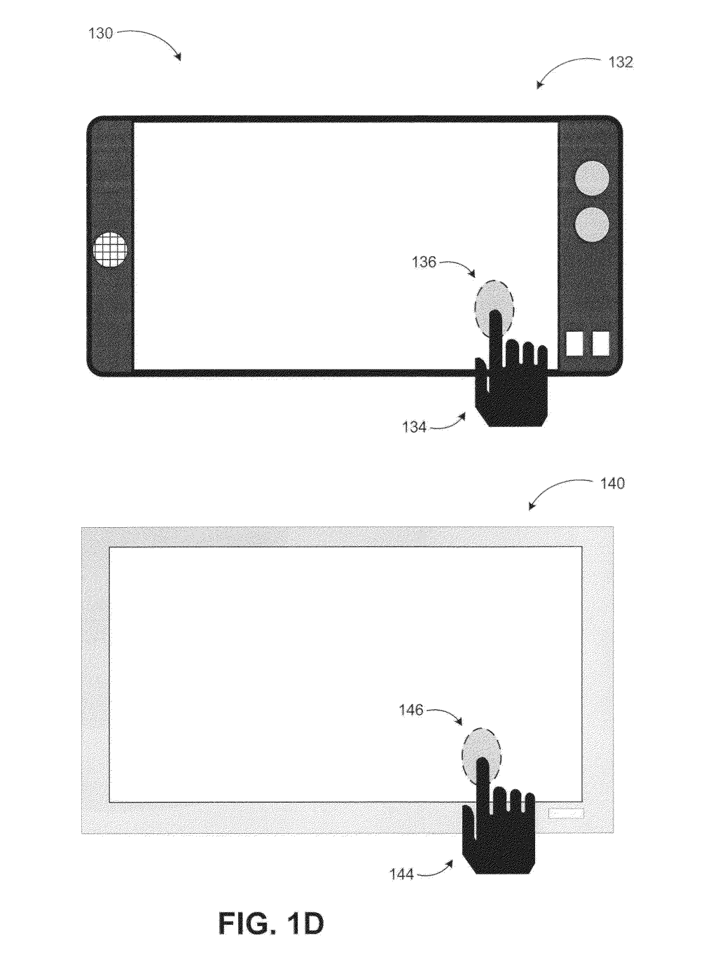

FIG. 1A through 1D illustrate example interactive devices, where various customizations may be performed based on detected user identity, arranged in accordance with at least some embodiments described herein.

As depicted in a diagram 100 of FIG. 1A, a wall panel 104 is an example of shared-use interactive surfaces for providing various computing services. The wall panel 104 may be, for example, a touch-capable or a gesture detecting, large size display. A user 102 may interact with the wall panel 104 through touch and/or gestures. In some examples, multiple users 108 may use the wall panel 104 at the same time or at different times. There may be custom operational aspects of the wall panel 104 or the underlying computing system for each user. For example, users may need to sign on with their distinct credentials, one or more user interface elements (e.g., presented controls, properties, etc.) may be adjusted to each user's preferences, one or more applications may be activated based on user needs/preferences, and so on.

Furthermore, in case of multiple users interacting with the wall panel 104 at the same time, the system may need to know which user is interacting with which part of the wall panel 104 in order to take proper actions (e.g., execute an application, associate the interaction with the user, etc.). Thus, the system underlying the wall panel 104 may need to determine the identity(ies) of the user(s) interacting with the wall panel.

In a system according to some embodiments, the user identity and customization based on the user identity may be determined by detecting a user identity attribute such as a finger orientation, an arm orientation, a handedness, a posture, and/or a DNA of a user. In some examples, more than one attribute may be detected to enhance a confidence level in the determined identity. The attribute(s) may be detected through an input device such as an optical detector, a touch detector, or a biological detector. The detection may be confined to a predefined area 106 on the wall panel 104 or it may be performed throughout a display surface of the wall panel 104. The wall panel 104 may also include conventional control mechanisms such as mechanical controls (e.g., keyboard, mouse, etc.), audio controls (e.g., speech recognition), and similar ones.

A diagram 110 in FIG. 1B illustrates another example large size interactive surface: a projected screen 112. The projected screen 112 may display a user interface such as a desktop of a computing device, one or more applications, and so on. For interactivity, an optical detector 114 (e.g., a camera) may be integrated with the projected screen 112 suitable for capturing gestures of the user 102 to control operational aspects of the underlying computing system. As in FIG. 1A, user identity attributes may be detected through a dedicated area 116 on the projected screen 112 or throughout a display surface.

A diagram 120 in FIG. 1C illustrates another example interactive surface: an interactive table 122. The interactive table 122 may include an interactive display surface 124 capable of displaying user interface(s) as well as accepting user input in form of touch or optically detected gestures. The interactive display surface 124 may be made from acrylic glass or similar material and provide hard or soft controls. Soft controls may be command buttons 128 or similar control elements displayed at predefined locations and activated by touch or gesture by the user 102. Hard controls may be any buttons, switches or comparable elements coupled to the interactive table 122. As in FIG. 1A or FIG. 1B, user identity attributes may be detected through a dedicated area 126 on the interactive table 122 or throughout the interactive display surface 124.

Two other example interactive devices are shown in a diagram 130 of FIG. 1D. A mobile device 132 may be a smartphone, a handheld control device, a special purpose device (e.g., a measurement device), or similar computing device with an interactive display surface, which may accept touch and/or gesture based user input 134. With a small form factor mobile device such as the mobile device 132, shared-use may be more commonly asynchronous compared to other types of devices discussed herein, but shared use is also possible in mobile devices. Still, the mobile device 132 may be used by different users at different times and detected user identities may be employed to customize operational aspects of the mobile device 132 as discussed herein. As in previous figures, user identity attributes may be detected through a dedicated area 136 on the interactive surface of the mobile device 132 or throughout the interactive display.

An interactive display 140 in the diagram 130 may be used in conjunction with a desktop or laptop computing device to display user interfaces and accept user input. As in previous figures, user identity attributes may be detected through a dedicated area 146 on the interactive display 140 or throughout the interactive display 140. As the example implementations in FIG. 1A through 1D illustrate, the devices employing user identity detection based customization may vary across a broad spectrum. On one end of the spectrum are handheld devices (e.g., a smartphone) with relatively small displays; on the other end are relatively large projection displays or television sets.

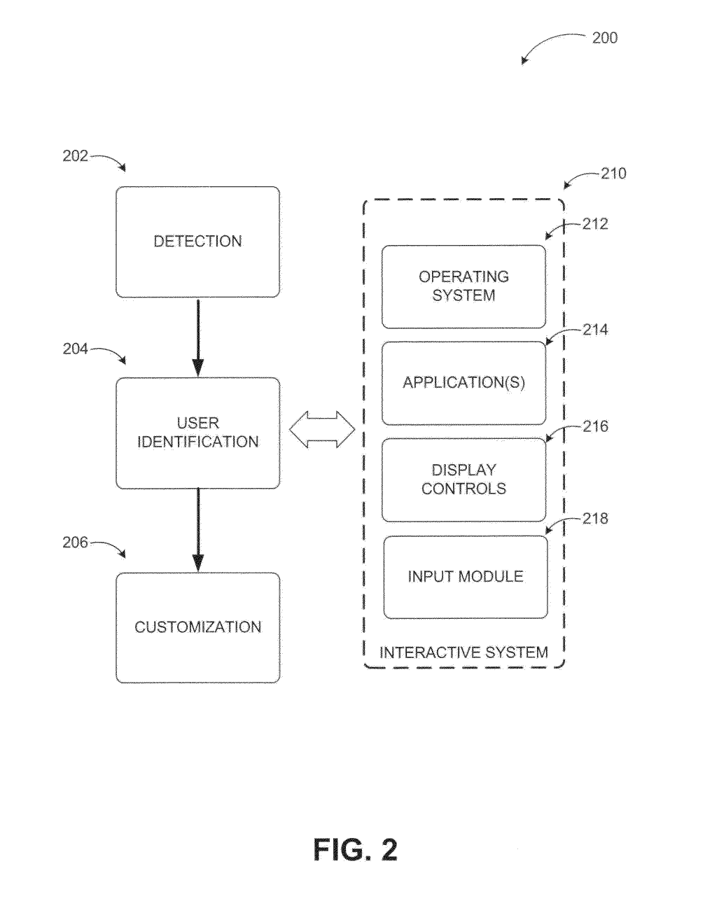

FIG. 2 illustrates major components and interactions in an interactive system capable of customization based on detected user identity, arranged in accordance with at least some embodiments described herein.

As shown in a diagram 200, an example system suitable for customizing operational aspects of a computing system associated with an interactive surface based on determining user identity through detection of one or more user identity attributes on the interactive surface may rely three components: a detection module 202, a user identification module 204, and a customization module 206. The computing system underlying the interactive surface (an interactive system 210) may include an operating system 212, one or more applications 214, display controls 216, and an input module 218. The detection module 202, the user identification module 204, and the customization module 206 may be part of the operating system 212, they may be a separate application, or they may be part of an application that performs additional tasks such as a display control application.

The detection module 202 may detect user identity attributes such as a finger orientation, an arm orientation, a handedness, a posture, and/or a DNA of a user through an input device associated or integrated with the interactive surface, for example, employing a camera-based Frustrated Total Internal Reflection (FTIR) system for capturing finger orientation through infrared light reflection. Using the finger is a common approach to interacting with touch/gesture based devices. Therefore, finger orientation may be a natural attribute that designers can make use of to discriminate user inputs.

For example, an interactive table may use strips of infrared lights to transmit through an acrylic glass. When a finger touches the glass, the infrared light may be bounced downward, which may then be captured by a camera mounted under the table. The reflected infrared lights may create a high contrast blob in the image, and the blobs may represent touches. A series of image processing techniques may be executed to extract the touch points. Finger orientations from people's natural pointing gesture are different from location to location. For example, when a user is standing at a south side of the table, his or her finger orientation is distinct from a user standing at the east side of the table.

In some examples, the detection module 202 may extract a shadow of a user's hand when the user is touching the interactive surface. In other examples, finger orientation may be captured via tiny cameras placed on the four corners of the surface and pointing inward to the screen. The user's finger orientations may then be reliably extracted. The user identification module 204 may use this finger orientation to train a machine learning system. Some examples of suitable machine learning systems may include decision tree learning systems, association rule learning systems, Bayesian networks, and comparable ones. Once trained, the user identification module 204 may correctly identify where and which the user is interacting with the interactive surface.

The customization module 206 may customize operational aspects such as those described above, based on the determined user identities (and/or locations of user interaction on the interactive surface). In other examples, a position awareness cursor (PAC) may be used to enable users to perform a self-correction when a prediction error occurs. In further examples, a position avatar may support users to move around the interactive surface while they continue interacting with the system using a desired user profile.

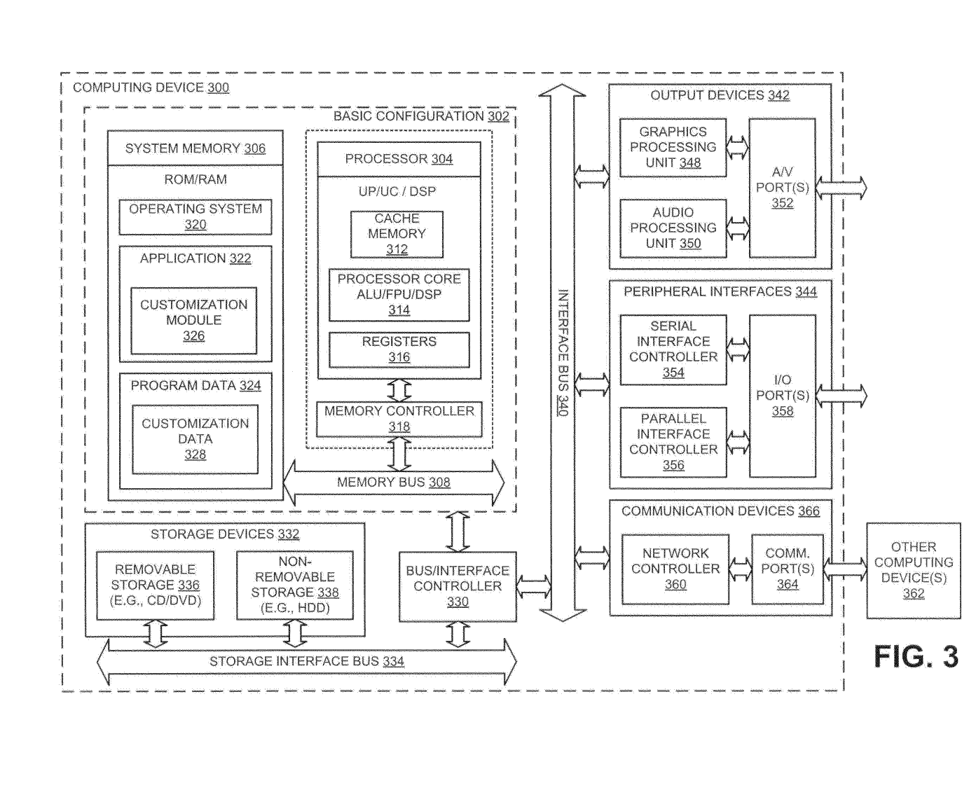

FIG. 3 illustrates a general purpose computing device, which may be used to customize operational aspects of an interactive surface based on user identity detection, arranged in accordance with at least some embodiments described herein. For example, the computing device 300 may be used to control interactive surfaces such as the example interactive displays 104, 112, or 124 of FIGS. 1A, 1B, and 1C, respectively. In an example basic configuration 302, the computing device 300 may include one or more processors 304 and a system memory 306. A memory bus 308 may be used for communicating between the processor 304 and the system memory 306. The basic configuration 302 is illustrated in FIG. 3 by those components within the inner dashed line.

Depending on the desired configuration, the processor 304 may be of any type, including but not limited to a microprocessor (μP), a microcontroller (μC), a digital signal processor (DSP), or any combination thereof. The processor 304 may include one more levels of caching, such as a level cache memory 312, a processor core 314, and registers 316. The example processor core 314 may include an arithmetic logic unit (ALU), a floating point unit (FPU), a digital signal processing core (DSP Core), or any combination thereof. An example memory controller 318 may also be used with the processor 304, or in some implementations the memory controller 318 may be an internal part of the processor 304.

Depending on the desired configuration, the system memory 306 may be of any type including but not limited to volatile memory (such as RAM), non-volatile memory (such as ROM, flash memory, etc.) or any combination thereof. The system memory 306 may include an operating system 320, one or more applications such as application 322, and program data 324. The application 322 may be executed in conjunction with an interactive surface and include a customization module 326, which may employ user identity detected through the interactive surface to customize operational aspects associated with the interactive surface as described herein. The program data 324 may include, among other data, customization data 328, or the like, as described herein.

The computing device 300 may have additional features or functionality, and additional interfaces to facilitate communications between the basic configuration 302 and any desired devices and interfaces. For example, a bus/interface controller 330 may be used to facilitate communications between the basic configuration 302 and one or more data storage devices 332 via a storage interface bus 334. The data storage devices 332 may be one or more removable storage devices 336, one or more non-removable storage devices 338, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 306, the removable storage devices 336 and the non-removable storage devices 338 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 300. Any such computer storage media may be part of the computing device 300.

The computing device 300 may also include an interface bus 340 for facilitating communication from various interface devices (e.g., one or more output devices 342, one or more peripheral interfaces 344, and one or more communication devices 366) to the basic configuration 302 via the bus/interface controller 330. Some of the example output devices 342 include a graphics processing unit 348 and an audio processing unit 350, which may be configured to communicate to various external devices such as a display or speakers via one or more A/V ports 352. One or more example peripheral interfaces 344 may include a serial interface controller 354 or a parallel interface controller 356, which may be configured to communicate with external devices such as input devices (e.g., keyboard, mouse, pen, voice input device, touch input device, etc.) or other peripheral devices (e.g., printer, scanner, etc.) via one or more I/O ports 358. An example communication device 366 includes a network controller 360, which may be arranged to facilitate communications with one or more other computing devices 362 over a network communication link via one or more communication ports 364. The one or more other computing devices 362 may include servers, mobile devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 300 may be implemented as a part of a general purpose or specialized server, mainframe, or similar computer that includes any of the above functions. The computing device 300 may also be implemented as a personal computer including both laptop computer and non-laptop computer configurations.

Example embodiments may also include methods for maintaining application performances upon transfer between cloud servers. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

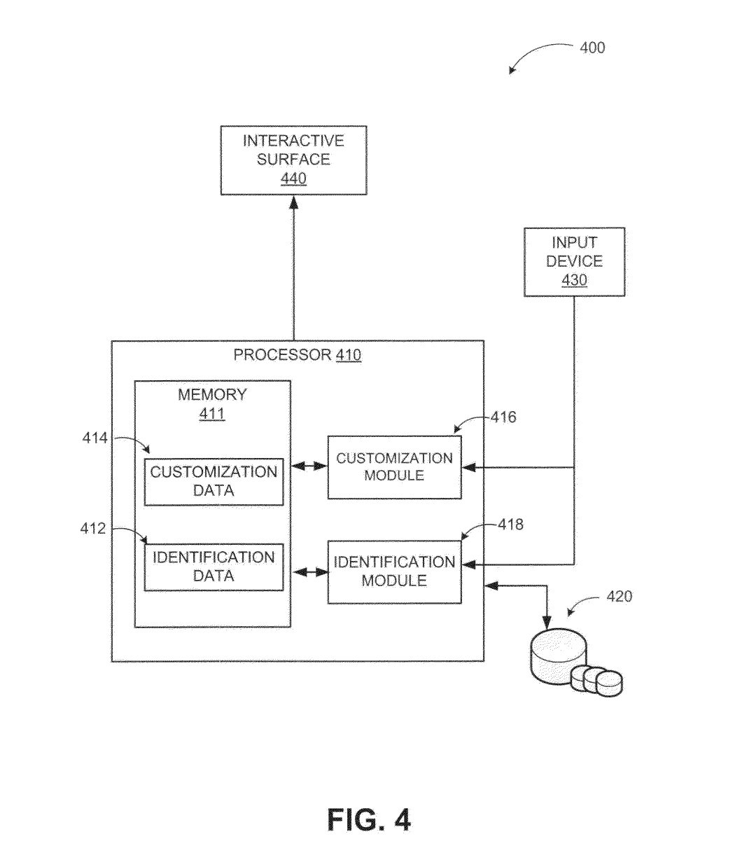

FIG. 4 illustrates a special purpose processor based system for customizing operational aspects of an interactive surface based on user identity detection, arranged in accordance with at least some embodiments described herein. As depicted in a diagram 400, a processor 410 may be part of a computing device with an interactive surface or any electronic device (e.g., a television, an ATM console, or comparable ones) with an interactive surface capable of being controlled by touch or gesture input.

The processor 410 may include a number of modules such as a customization module 416 and an identification module 418 configured to communicate with capture devices such as an input device 430 to capture user identity attribute(s) like a finger orientation, arm orientation, posture, DNA, or other attributes. Upon detection of the attribute by the identification module 418, the processor 410 may adjust an operational aspect associated with the interactive surface depending on a user identity determined from the detected attribute.

A memory 411 may be configured to store instructions for the control modules of the processor 410, which may be implemented as hardware, software, or combination of hardware and software. Some of the data may include, but is not limited to, customization data 414, identification data 412, or similar information. The processor 410 may be configured to communicate through electrical couplings or through networked communications with other devices, for example, a interactive surface 440 and/or data stores such as a storage facility 420.

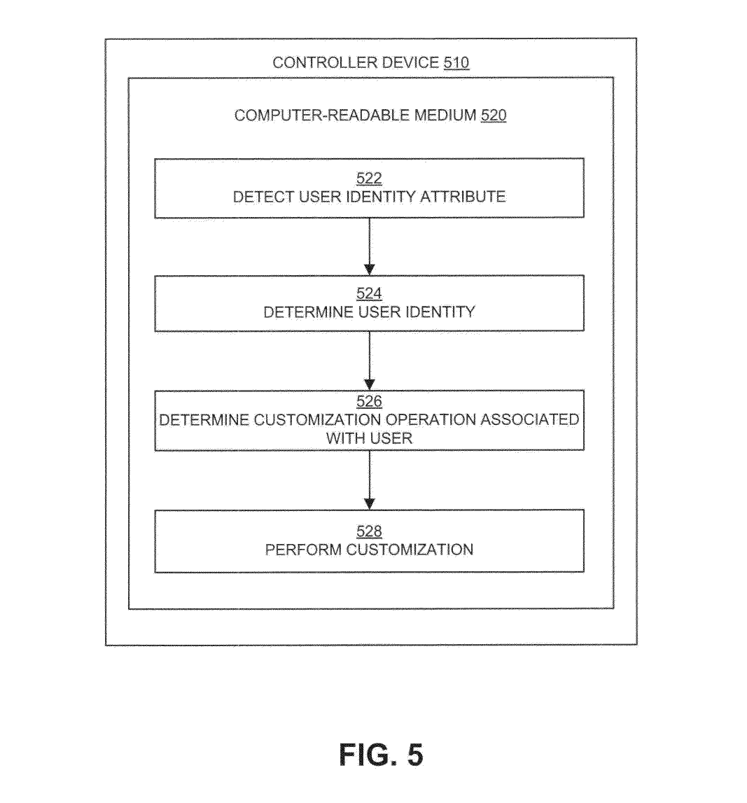

FIG. 5 is a flow diagram illustrating an example method that may be performed by a computing device such as the device in FIG. 4, arranged in accordance with at least some embodiments described herein. Example methods may include one or more operations, functions or actions as illustrated by one or more of blocks 522, 524, 526, and/or 528. The operations described in the blocks 522 through 528 may also be stored as computer-executable instructions in a computer-readable medium such as a computer-readable medium 520 of a computing device 510.

An example process for detecting user identity on interactive surfaces and customization based on the detected identity may begin with block 522, “DETECT USER IDENTITY ATTRIBUTE”, where an identification module may detect a user identity attribute such as a finger orientation, an arm orientation, a posture, a DNA, or similar attributes through an input device associated or integrated with an interactive surface such as interactive surface 124 of FIG. 1C.

Block 522 may be followed by block 524, “DETERMINE USER IDENTITY”, where a user's identity may be determined based on the detected user identity attribute at block 522. Block 524 may be followed by block 526, “DETERMINE CUSTOMIZATION OPERATION ASSOCIATED WITH USER”, where a customization operation may be determined based on the user identity determined at block 524. The customization operation may be activation of a user credential, adjustment of a user interface attribute, activation of an application, or similar actions. Block 526 may be followed by block 528, “PERFORM CUSTOMIZATION”, where the customization operation determined at block 526 may be executed by a processor of the interactive surface such as the processor 410 of FIG. 4.

The blocks included in the above described process are for illustration purposes. Detecting user identity on interactive surfaces and customization based on the detected identity may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

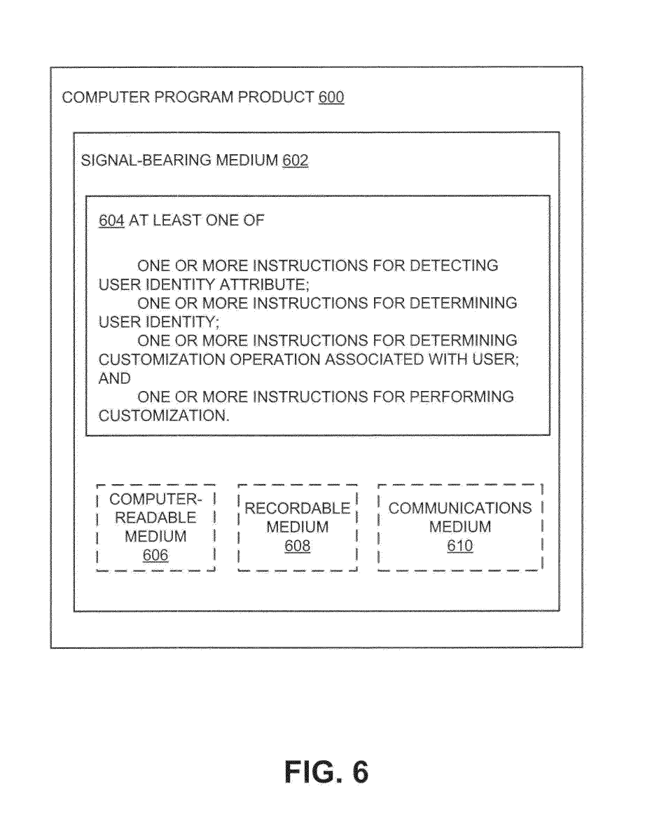

FIG. 6 illustrates a block diagram of an example computer program product, arranged in accordance with at least some embodiments described herein.

In some embodiments, as shown in FIG. 6, the computer program product 600 may include a signal bearing medium 602 that may also include one or more machine readable instructions 604 that, when executed by, for example, a processor, may provide the functionality described herein. Thus, for example, referring to the processor 304 in FIG. 3, the customization module 526 may undertake one or more of the tasks shown in FIG. 6 in response to the instructions 604 conveyed to the processor 304 by the medium 602 to perform actions associated with detecting user identity on interactive surfaces and customization based on the detected identity as described herein. Some of those instructions may include, for example, instructions for detecting a user identity attribute, determining a user identity, determining a customization operation associated with the user, and performing the customization according to some embodiments described herein.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 604 by an RF signal bearing medium, where the signal bearing medium 602 is conveyed by the wireless communications medium 610 (e.g., a wireless communications medium conforming with the IEEE 802.11 standard).

According to some examples, a method for detecting user identity on interactive surfaces may include detecting a user identity attribute on an interactive surface, determining a user identity based on the detected attribute, determining a customization operation associated with the user identity, and performing the customization operation.

According to other examples, the user identity attribute may include one or more of a finger orientation, a finger weight/pressure, a separation between fingers, a finger length, an arm orientation, a handedness, a posture, and/or a DNA of a user. The method may further include detecting the user identity attribute through an input device associated with the interactive surface, where the input device is one of: an optical detector, a touch detector, or a biological detector, and detecting the user identity attribute through a camera-based Frustrated Total Internal Reflection (FTIR) system, an overhead camera, or Diffuse Illumination integrated with the interactive surface. The method may also include transmitting infrared light to a display screen internally, capturing a reflection of the transmitted infrared light internally, and determining the finger orientation from the captured reflection.

According to further examples, the method may include employing at least one of the arm orientation, the handedness, the posture, and/or the DNA to complement the finger orientation in determining the user identity, detecting multiple user identity attributes on a multi-touch interactive surface, and/or determining multiple user identities based on the detected attributes. The method may also include employing a position avatar to enable a user to move around the interactive surface while continuing to interact with the interactive surface using the determined user identity. The method may also capture user movement through a floor mat, an overhead camera or any other user movement capture method and associate input with the user at any given position around the device.

According to yet other examples, the method may include employing a position awareness cursor to enable a user to perform self-correction in response to a prediction error. The user identity attribute may be detected on a dedicated area of the interactive surface. The customization operation may include one or more of activating a user credential, adjusting a user interface setting, and/or activating an application. The interactive surface may be an interactive table computer, a wall panel, a mobile computing device, an interactive projection surface, a desktop computer, a vehicle-mount computer, or a wearable computer.

According to other examples, a computing device capable of customizing operational aspects based on detecting a user identity may include a memory configured to store instructions and a processing unit configured to execute a customization module in conjunction with the instructions. The customization module may be configured to detect a user identity attribute on an interactive surface associated with the computing device, determine the user identity based on the detected attribute, determine a customization operation associated with the user identity, and perform the customization operation.

According to some examples, the user identity attribute may include one or more of a finger orientation, a finger weight/pressure, a separation between fingers, a finger length, an arm orientation, a handedness, a posture, and/or a DNA of a user. The customization module may be further configured to detect the user identity attribute through an input device associated with the interactive surface, where the input device is one of: an optical detector, a touch detector, or a biological detector. The customization module may also be configured to detect the user identity attribute through a camera-based Frustrated Total Internal Reflection (FTIR) system, an overhead camera, or Diffuse Illumination integrated with the interactive surface, transmit infrared light to a display screen internally, capture a reflection of the transmitted infrared light internally, and determine the finger orientation from the captured reflection.

According to further examples, the customization module may be configured to employ at least one of the arm orientation, the handedness, the posture, and/or the DNA to complement the finger orientation in determining the user identity; detect multiple user identity attributes on a multi-touch interactive surface; and/or determine multiple user identities based on the detected attributes. The customization module may also be configured to employ a position avatar to enable a user to move around the interactive surface while continuing to interact with the interactive surface using the determined user identity.

According to yet other examples, the customization module may be configured to employ a position awareness cursor to enable a user to perform self-correction in response to a prediction error. The user identity attribute may be detected on a dedicated area of the interactive surface. The customization operation may include one or more of activating a user credential, adjusting a user interface setting, and/or activating an application. The computing device may be an interactive table computer, a wall panel, a mobile computing device, an interactive projection surface, a desktop computer, a vehicle-mount computer, or a wearable computer.

According to further examples, a computer-readable storage medium may have instructions stored thereon for detecting user identity on interactive surfaces. The instructions may include detecting a user identity attribute on an interactive surface, determining a user identity based on the detected attribute, determining a customization operation associated with the user identity, and performing the customization operation.

According to yet other examples, the user identity attribute may include one or more of a finger orientation, a finger weight/pressure, a separation between fingers, a finger length, an arm orientation, a handedness, a posture, and/or a DNA of a user. The instructions may further include detecting the user identity attribute through an input device associated with the interactive surface, where the input device is one of: an optical detector, a touch detector, or a biological detector, and detecting the user identity attribute through a camera-based Frustrated Total Internal Reflection (FTIR) system, an overhead camera, or Diffuse Illumination integrated with the interactive surface. The instructions may also include transmitting infrared light to a display screen internally, capturing a reflection of the transmitted infrared light internally, and determining the finger orientation from the captured reflection.

According to other examples, the instructions may include employing at least one of the arm orientation, the handedness, the posture, and/or the DNA to complement the finger orientation in determining the user identity, detecting multiple user identity attributes on a multi-touch interactive surface, and/or determining multiple user identities based on the detected attributes. The instructions may also include employing a position avatar to enable a user to move around the interactive surface while continuing to interact with the interactive surface using the determined user identity.

According to some examples, the instructions may include employing a position awareness cursor to enable a user to perform self-correction in response to a prediction error. The user identity attribute may be detected on a dedicated area of the interactive surface. The customization operation may include one or more of activating a user credential, adjusting a user interface setting, and/or activating an application. The interactive surface may be an interactive table computer, a wall panel, a mobile computing device, an interactive projection surface, a desktop computer, a vehicle-mount computer, or a wearable computer.

According to yet other examples, a user identity based customization module for use in conjunction with an interactive surface may include an input device associated with the interactive surface and a processing unit. The processing unit may detect a user identity attribute on the interactive surface, determine the user identity based on the detected attribute, determine a customization operation associated with the user identity, and perform the customization operation.

According to some examples, the user identity attribute may include one or more of a finger orientation, a finger weight/pressure, a separation between fingers, a finger length, an arm orientation, a handedness, a posture, and/or a DNA of a user. The input device may be an optical detector, a touch detector, or a biological detector. The processing unit may also detect the user identity attribute through a camera-based Frustrated Total Internal Reflection (FTIR) system, an overhead camera, or Diffuse Illumination integrated with the interactive surface, and perform one or more of transmit infrared light to a display screen internally; capture a reflection of the transmitted infrared light internally; and determine the finger orientation from the captured reflection.

According to further examples, the processing unit may employ at least one of the arm orientation, the handedness, the posture, and/or the DNA to complement the finger orientation in determining the user identity. The processing unit may also detect multiple user identity attributes on a multi-touch interactive surface and determine multiple user identities based on the detected attributes. The processing unit may further employ a position avatar to enable a user to move around the interactive surface while continuing to interact with the interactive surface using the determined user identity, or employ a position awareness cursor to enable a user to perform self-correction in response to a prediction error. The user identity attribute may be detected on a dedicated area of the interactive surface. The customization operation may include one or more of activating a user credential, adjusting a user interface setting, and/or activating an application. The customization module may also be integrated into an interactive table computer, a wall panel, a mobile computing device, an interactive projection surface, a desktop computer, a vehicle-mount computer, or a wearable computer.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various examples of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular examples described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for detecting user identity on interactive surfaces, the method comprising:
detecting a user identity attribute on an interactive surface through;
transmitting infrared light to a display screen internally;
capturing a reflection of the transmitted infrared light internally; and
determining at least one of an arm orientation, a handedness, a posture, and/or a finger orientation from the captured reflection;
determining a user identity based on the detected user identity attribute;
determining a customization operation associated with the user identity; and
performing the customization operation.

2. The method according to claim 1, wherein the user identity attribute further includes one or more of a finger weight/pressure, a separation between fingers, a finger length, and/or a DNA of a user.

3. The method according to claim 2, further comprising:
detecting the user identity attribute through an input device associated with the interactive surface, wherein the input device is one of: an optical detector, a touch detector, or a biological detector.

4. The method according to claim 3, further comprising:
detecting the user identity attribute through one of a camera-based Frustrated Total Internal Reflection (FTIR) system, an overhead camera, or Diffuse Illumination integrated with the interactive surface.

5.-6. (canceled)

7. The method according to claim 1, further comprising:
detecting multiple user identity attributes on a multi-touch interactive surface; and
determining multiple user identities based on the detected attributes.

8. The method according to claim 7, further comprising:
employing a position avatar to enable a user to move around the interactive surface while continuing to interact with the interactive surface using the determined user identity.

9. The method according to claim 1, further comprising:
employing a position awareness cursor to enable a user to perform self-correction in response to a prediction error.

10. The method according to claim 1, wherein the user identity attribute is detected on a dedicated area of the interactive surface.

11.-12. (canceled)

13. A computing device capable of customizing operational aspects based on detecting a user identity, the computing device comprising:
a memory configured to store instructions; and
a processing unit configured to execute a customization module in conjunction with the instructions, wherein the customization module is configured to:
transmit infrared light to a display screen internally;
capture a reflection of the transmitted infrared light internally; and
determine at least two user identity attributes comprising: an arm orientation, a handedness, a posture, and/or a finger orientation from the captured reflection;
determine the user identity based on the detected user identity attributes;
determine a customization operation associated with the user identity; and
perform the customization operation.

14. The computing device according to claim 13, wherein the user identity attribute further includes one or more of a finger weight/pressure, a separation between fingers, a finger length, and/or a DNA of a user.

15. (canceled)

16. The computing device according to claim 14, wherein the customization module is further configured to:
detect the user identity attribute through a camera-based Frustrated Total Internal Reflection (FTIR) system, an overhead camera, or Diffuse Illumination integrated with the interactive surface.

17.-18. (canceled)

19. The computing device according to claim 13, wherein the customization module is further configured to:
detect multiple user identity attributes on a multi-touch interactive surface; and
determine multiple user identities based on the detected attributes.

20.-22. (canceled)

23. The computing device according to claim 13, wherein the customization operation includes one or more of activating a user credential, adjusting a user interface setting, and/or activating an application.

24. The computing device according to claim 13, wherein the computing device is one of an interactive table computer, a wall panel, a mobile computing device, an interactive projection surface, a desktop computer, a vehicle-mount computer, or a wearable computer.

25.-36. (canceled)

37. A user identity based customization module for use in conjunction with an interactive surface, the customization module comprising:
an input device associated with the interactive surface; and
a processing unit configured to:
transmit infrared light to a display screen internally;
capture a reflection of the transmitted infrared light internally; and
determine multiple user identity attributes comprising: an arm orientation, a handedness, a posture, and/or a finger orientation from the captured reflection;
determine multiple user identities based on the detected user identity attributes;
determine a customization operation associated with the user identities; and
perform the customization operation.

38. The customization module according to claim 37, wherein the user identity attribute further includes one or more of a finger weight/pressure, a separation between fingers, a finger length, and/or a DNA of a user.

39. The customization module according to claim 38, wherein the input device is one of: an optical detector, a touch detector, or a biological detector.

40. The customization module according to claim 39, wherein the processing unit is further configured to:
detect the user identity attribute through a camera-based Frustrated Total Internal Reflection (FTIR) system, an overhead camera, or Diffuse Illumination integrated with the interactive surface.

41.-44. (canceled)

45. The customization module according to claim 37, wherein the processing unit is further configured to:
employ a position awareness cursor to enable a user to perform self-correction in response to a prediction error.

46. The customization module according to claim 37, wherein the user identity attribute is detected on a dedicated area of the interactive surface.

47.-48. (canceled)
